(19) United States
(12) Patent Application Publication
(10) Pub. No.: US 2013/0241975 A1
(43) Pub. Date: Sep. 19, 2013

(54) LIQUID CRYSTAL DISPLAY

(71) Applicants: Shigesumi ARAKI, Hakusan-shi (JP); Kazuhiro Nishiyama, Kanazawa-shi (JP); Noriyoshi Kanda, Kanazawa-shi (JP); Kenji Nakao, Kanazawa-shi (JP)

(72) Inventors: Shigesumi ARAKI, Hakusan-shi (JP); Kazuhiro Nishiyama, Kanazawa-shi (JP); Noriyoshi Kanda, Kanazawa-shi (JP); Kenji Nakao, Kanazawa-shi (JP)

(21) Appl. No.: 13/792,510

(22) Filed: Mar. 11, 2013

(30) Foreign Application Priority Data
Mar. 15, 2012 (JP) 2012-058487

(51) Int. Cl. G09G 3/36

(52) U.S. Cl. CPC G09G 3/36
USPC 345/691

(57) ABSTRACT

According to one embodiment, a liquid crystal display includes first light sources disposed side by side in a scan direction, a first light guide to guide the light emitted from the first light sources in a first direction, second light sources disposed side by side in the scan direction, a second light guide to guide the light emitted from the second light sources in a second direction, and a light source driver to independently turn on and turn off the first and second light sources. The light source driver sequentially turns on and turns off the first light sources in a first period. The light source driver sequentially turns on and turns off the second light sources in a second period.

### CROSS-REFERENCE TO RELATED APPLICATIONS

This application is based upon and claims the benefit of priority from Japanese Patent Application No. 2012-058487, filed Mar. 15, 2012, the entire contents of which are incorporated herein by reference.

### FIELD

Embodiments described herein relate generally to a liquid crystal display.

### BACKGROUND

A liquid crystal display is widely used as a display of a personal computer, an information mobile terminal, a television, or a car navigation system, and the like making use of its feature of light in weight, thin thickness, low power consumption, and the like.

Recently, there is proposed a liquid crystal display capable of not only displaying two-dimensional information but also making a three-dimensional display or displaying different images on the same screen at the same time. There are proposed, for example, a vehicle-mounted two-screen display on which a picture viewed from a driver's seat is different from a picture viewed from a picture viewed from an assistant driver's seat, a three-dimensional display for making a three-dimensional display by displaying a right eye picture and a left eye picture, respectively.

As described above, since the two-screen display and the three-dimensional display make the two-screen display and the three-dimensional display by switching the right-eye picture and the left-eye picture at high speed, high speed liquid crystal responsiveness is required thereto as compared with a display that displays two-dimensional information.

Further, an illumination unit for illuminating liquid crystal pixels is also required to control turning on/off timing so that a light emitting direction is switched according to a picture switching operation.

### BRIEF DESCRIPTION OF THE DRAWINGS

FIG. 1 is a view schematically illustrating a configuration example of a liquid crystal display of an embodiment;

FIG. 2 is a view explaining an operation example of a backlight in the liquid crystal display of the embodiment;

FIG. 3 is a view illustrating an example of the connection relation between output terminals of a backlight drive unit and light sources;

FIG. 4 is a view illustrating other example of the connection relation between the output terminal of the backlight drive unit and the light sources;

FIG. 5 is a view explaining an example of a drive method when a 2D display is made in the liquid crystal display illustrated in FIG. 2;

FIG. 6 is a view explaining an example of a turning on/off operation of light sources of a backlight at the time of 2D display;

FIG. 7 is a view explaining an example of a drive method when a 3D-display is made in the liquid crystal display illustrated in FIG. 2;

FIG. 8 is a view explaining an example of a turning on/off operation of light sources of a backlight at the time of 3D-display; and

FIG. 9 is a view explaining an example of a turning on/off operation of the light sources of the backlight at the time of 3D-display.

### DETAILED DESCRIPTION

In general, according to one embodiment, a liquid crystal display, comprises a pair of substrates; a liquid crystal layer sandwiched between the pair of substrates; a plurality of liquid crystal pixels disposed in a matrix state; a drive circuit configured to drive the liquid crystal pixels; a plurality of first light sources disposed side by side in a scan direction along which the liquid crystal pixels are scanned by the drive circuit; a first light guide configured to guide the light emitted from the first light sources in a first direction; a plurality of second light sources disposed side by side in the scan direction; a second light guide configured to guide the light emitted from the second light sources in a second direction different from the first direction; and a light source drive unit configured to be able to independently turn on and turn off the first light sources and the second light sources. The light source drive unit sequentially turns on and turns off the first light sources along the scan direction in a first subframe period. The light source drive unit sequentially turns on and turns off the second light sources along the scan direction in a second subframe period succeeding to the first subframe period, and the light source drive unit turns off all the first light sources and the second light sources before a picture signal begins to be written in a next subframe period.

The liquid crystal display of the embodiment will be explained below referring to drawings.

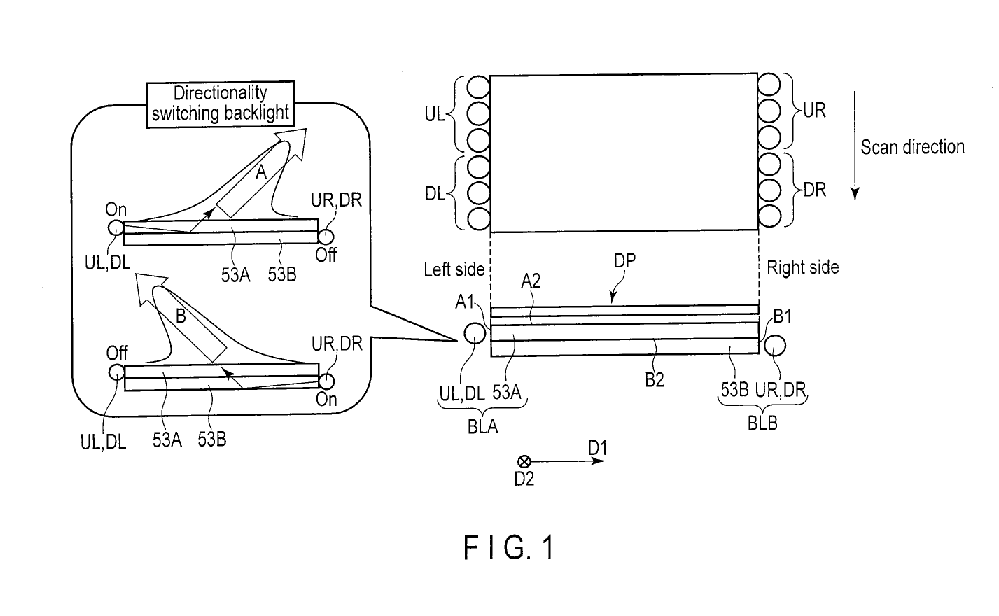

FIG. 1 is a view explaining an operation example of a backlight in the liquid crystal display of the embodiment.

The liquid crystal display according to the invention includes a backlight BL on a back surface side of a transmission liquid crystal panel DP. The backlight BL has a first the backlight BLA and a second backlight BLB. The first the backlight BLA has a plurality of first light sources (upper left light source UL, lower left light source DL) and a backlight guide plate 53A as a first light guide. The second backlight BLB has a plurality of second light sources (upper right light source UR, lower right light source DR) and a backlight guide plate 53B as a second light guide.

When the upper left light source UL and the lower left light source DL are turned on, light is emitted in a right direction (first direction A) of the drawing by the backlight guide plate 53A, whereas when the upper right light source UR and the lower right light source DR are turned on, light is emitted in a left direction (second direction B) of the drawing by the backlight guide plate 53B.

The upper left light source UL and the lower left light source DL are disposed side by side in a scan direction in the vicinity of an end surface of the backlight guide plate 53A and the turning on/off timing of which can be independently controlled as described later. Further, the upper right light source UR and the lower right light source DR are disposed side by side in the scan direction in the vicinity of an end surface of the backlight guide plate 53B and the turning on/off timing of which can be independently controlled as described later. The upper left light source UL and the lower left light source DL, and the upper right light source UR and the lower right light source DR are disposed on both sides in a direction approximately orthogonal to the scan direction so that the backlight guide plates 53A, 53B are sandwiched between both the sides.

When a three-dimensional display (3D display) for displaying 3D contents is made, the upper left light source UL and the lower left light source DL are turned on and turned off at predetermined timing during a period in which the right eye image is displayed on the liquid crystal panel DP and the upper right light source UR and the lower right light source DR are turned on and turned off at predetermined timing by switching the light sources during a period in which the left eye image is displayed on the liquid crystal panel DP. Right and left stereoscopic images can be guided to right and left eyes, respectively by sequentially displaying the right and left stereoscopic images on the liquid crystal panel DP by time division as described above and switching the directionality of the light sources for executing illumination in synchronization with the sequential display.

When a two-dimensional display (2D display) for displaying the 2D contents is made, the upper left light source UL and the lower left light source DL, and the upper right light source UR and the lower right light source DR are turned on and turned off at predetermined timing depending on a period in which an image is displayed on the liquid crystal panel DP.

Note that, in the 3D display and the 2D display, the timing at which the upper left light source UL, the lower left light source DL, the upper right light source UR, and the lower right light source DR are turned on will be explained later in detail. The 2D contents are contents including only images that are visually recognized on both the sides of a right side (particularly, a direction inclined to the right side from a direction perpendicular to a first direction D1 and a second direction D2) and a left side (particularly, a direction inclined to the left side from a direction perpendicular to the first direction D1 and the second direction D2). The 3D contents are contents including an image displayed to a right side (visually recognized from a direction inclining to the right side) and an image displayed to a left side (visually recognized from a direction inclining to the left side) and includes not only the contents delivered as the 3D contents but also the contents created by the 2D contents.

FIG. 1 illustrates a schematic configuration of the liquid crystal display. In an actual display, an optical element for adjusting the directionality of light such as a collimate lens, a prism film, and the like can be further disposed appropriately between the liquid crystal panel DP and the backlight BL.

Further, to display a different picture by time-dividing one frame period, it is an indispensable condition to use liquid crystal having a high response speed. Accordingly, in the embodiment, an OCB mode (Optically Compensated Bend) liquid crystal, which has high speed liquid crystal responsiveness necessary to display a motion picture and can realize a wide viewing angle, is used.

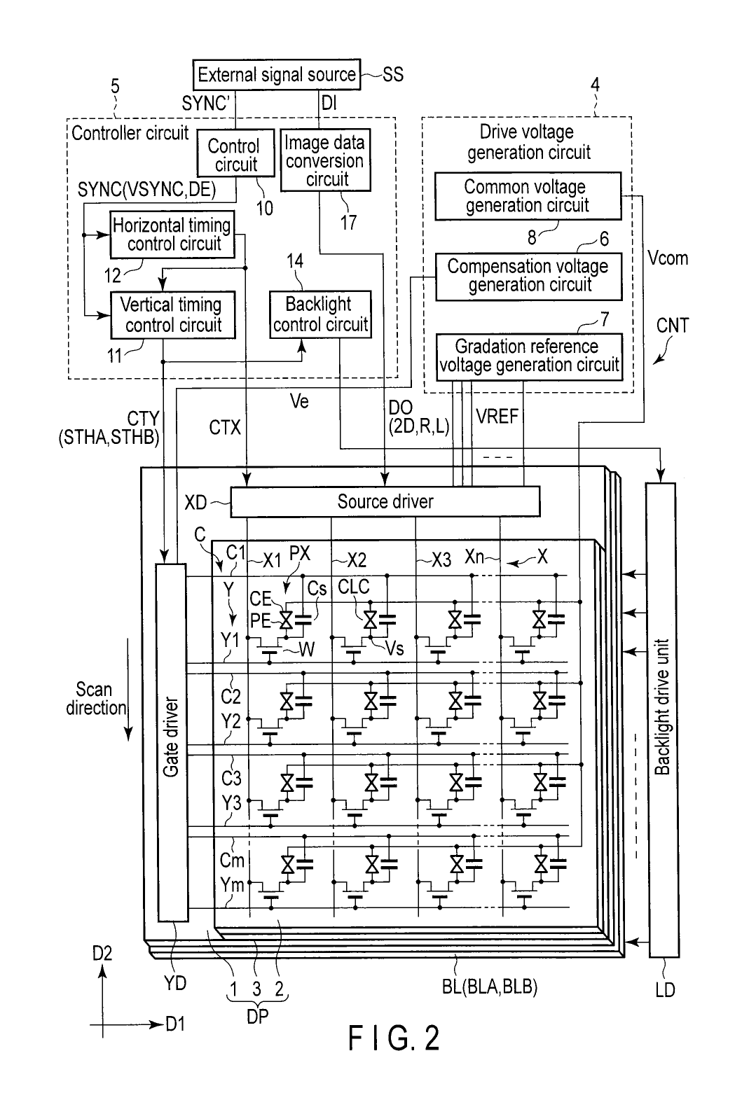

FIG. 2 is a view schematically illustrating a circuit configuration of the liquid crystal display. The liquid crystal display of the embodiment includes the liquid crystal panel DP, the backlight BL (BLA, BLB) for illuminating the liquid crystal panel DP, and a display control circuit CNT for controlling the liquid crystal panel DP and the backlight BL.

The liquid crystal panel DP has an array substrate 1 and a confronting substrate 2 that are a pair of electrode substrates, a liquid crystal layer 3 sandwiched between the pair of electrode substrates, a display area having a plurality of liquid crystal pixels PX, and a drive unit for driving a plurality of display pixels PX. The liquid crystal layer 3 includes a liquid crystal material, which is previously transited from splay orientation to bend orientation for a display operation of, for example, normally white and whose reverse transition from bend orientation to splay orientation is prevented by a voltage (reverse transition prevention voltage) applied thereto, as liquid crystal.

The display control circuit CNT controls the transmittance of the liquid crystal panel DP by a liquid crystal drive voltage applied from the array substrate 1 and the confronting substrate 2 to the liquid crystal layer 3. The transition from splay orientation to bend orientation can be obtained by applying a relatively large electric field to the liquid crystal in a predetermined initialization process executed by the display control circuit CNT at the time of energization.

In the array substrate 1, a plurality of pixel electrodes PE are disposed on a transparent insulation substrate GL in an approximate matrix. Further, a plurality of gate wires Y (Y1-Ym) are disposed along the row of the plurality of pixel electrodes PE (or extending in the first direction D1), and a plurality of source wires X (X1-Xn) are disposed along the column of the pixel electrodes PE (or extending in the second direction D2).

A plurality of pixel switching elements W is disposed in the vicinity of the positions where the gate wires Y intersect the source wires X. Each of the pixel switching elements W has a thin film transistor having, for example, a gate connected to a gate wire Y and a source-drain path connected between a source wire X and a pixel electrode PE, and when the pixel switching element W is driven via a corresponding gate wire Y, the pixel switching element W is electrically conducted between the corresponding source wire X and the corresponding pixel electrode PE.

Each pixel electrode PE and a common electrode CE include, for example, a transparent electrode material such as ITO and the like and are covered with an orientation film (not illustrated), respectively and constitute a liquid crystal pixel PX together with a pixel region that is a portion of the liquid crystal layer 3 controlled by the disposition of a liquid crystal molecule corresponding to the electric field from the pixel electrode PE and the common electrode CE. The plurality of liquid crystal pixels PX is disposed in matrix in the display area of the liquid crystal panel DP.

Each of the liquid crystal pixels PX has a liquid crystal capacitance CLC between each pixel electrode PE and the common electrode CE. Each of a plurality of auxiliary capacitance wires C1-Cm is capacitance-coupled with a pixel electrode PE of a liquid crystal pixel PX of each correspond row and constitutes an auxiliary capacitance Cs. The auxiliary capacitance Cs has a sufficiently large capacitance value to the parasitic capacitance of the pixel switching elements W.

The display control circuit CNT includes a drive unit (a gate driver YD, a source driver XD), a backlight drive unit LD, a drive voltage generation circuit 4 and a controller circuit 5.

The gate driver YD sequentially drives the gate wires Y1-Ym to electrically conduct the plurality of pixel switching elements W in a unit of row. The source driver XD outputs pixel voltages Vs to the plurality of source wires X1-Xn during a period in which the pixel switching elements W of each row are electrically conducted by driving the corresponding gate wire Y. The backlight drive unit LD drives the backlight BL. The drive voltage generation circuit 4 generates a drive voltage of the liquid crystal panel DP. The controller circuit 5 controls the gate driver YD, the source driver XD, and the backlight drive unit LD.

The drive voltage generation circuit 4 includes a compensation voltage generation circuit 6, a gradation reference voltage generation circuit 7, and a common voltage generation circuit 8. The compensation voltage generation circuit 6 generates a compensation voltage Ve applied to the auxiliary capacitance wires C. The gradation reference voltage generation circuit 7 generates a predetermined number of gradation reference voltages VREF used by the source driver XD. The common voltage generation circuit 8 generates a common voltage Vcom applied to a confronting electrode CT.

The controller circuit 5 includes a control circuit 10, a vertical timing control circuit 11, a horizontal timing control circuit 12, an image data conversion circuit 17, and a backlight control circuit 14.

The control circuit 10 creates a new synchronization signal SYNC (VSYNC, DE) based on a synchronization signal SYNC′ input from an external signal source SS and creates a signal for controlling the operation of the respective portions of the display control circuit CNT.

The vertical timing control circuit 11 generates a control signal CTY to the gate driver YD, and the like based on the synchronization signal SYNC (VSYNC, DE) input from the control circuit 10.

The horizontal timing control circuit 12 generates a control signal CTX to the source driver XD based on the synchronization signal SYNC (VSYNC, DE) input from the control circuit 10.

The image data conversion circuit 17 temporarily stores image data DI (left image data L, right image data R, two-dimensional image data 2D), which is input from the external signal source SS, to the plurality of liquid crystal pixels PX and outputs the image data DI to the source driver XD at predetermined timing.

The backlight control circuit 14 controls the backlight drive unit LD based on the control signal CTY output from the vertical timing control circuit 11.

The image data DI includes a plurality of pixel data to the plurality of liquid crystal pixels PX and, when the 3D display is made, the image data DI is updated twice as to the left image data and the right image data in the one frame period (vertical scan period).

The control signal CTY is supplied to the gate driver YD, and the control signal CTX is supplied to the source driver XD together pixel data DO that can be obtained from the image data conversion circuit 17. As described above, the control signal CTY is used to cause the gate driver YD to execute an operation for sequentially driving the plurality of gate wires Y, and the control signal CTX is used to cause the source driver XD to execute an operation for allocating the pixel data DO, which are obtained in the unit of the liquid crystal pixels PX of the image data conversion circuit 17 and are output in series, to the plurality of source wires X, respectively and designating an output polarity.

The gate driver YD is configured using, for example, a shift register circuit to select the gate wires Y. Gate pulses are shifted by the shift register circuit at predetermined timing and sequentially output to the gate wires Y.

The source driver XD converts the pixel data DO to the pixel voltages Vs, respectively referring to the predetermined number of the gradation reference voltages VREF supplied from the gradation reference voltage generation circuit 7 and outputs the pixel voltages Vs to the plurality of source wires X1-Xn. Further, the source driver XD outputs the reverse transition prevention voltage for preventing the liquid crystal layer 3 from being reverse transited from bend orientation to splay orientation to the source wires X1-Xn in parallel.

The pixel voltages Vs are voltages applied to the pixel electrodes PE using the common voltage Vcom of the common electrode CE as a reference and the polarity thereof is inverted to the common voltage Vcom to execute, for example, a frame inversion drive and a line inversion drive. When a reflecting portion display drive is executed at a double vertical scan speed, the polarity is inverted to the common voltage Vcom to execute, for example, the line inversion drive (1H inversion drive) and the frame inversion drive.

Further, when the pixel switching elements W of one row become not electrically conducted, the compensation voltage Ve may be applied to the auxiliary capacitance wires C corresponding to the gate wires Y connected to the pixel switching elements W via the gate driver YD and may be a capacitance coupling drive for compensating the fluctuation of the pixel voltages Vs generated to the pixels PX of one row by the parasitic capacitance of the pixel switching elements W.

When the gate driver YD drives the gate wires Y1 by, for example, an on-voltage and electrically conducts all the pixel switching elements W connected to the gate wires Y1, the pixel voltages Vs or the reverse transition prevention voltage applied to the source wires X1-Xn is supplied to one ends of the corresponding pixel electrodes PE and the auxiliary capacitance Cs via the pixel switching elements W, respectively.

Further, just after the gate driver YD has output the compensation voltage Ve from the compensation voltage generation circuit 6 to the auxiliary capacitance wire C1 corresponding to the gate wire Y1 and has electrically conducted all the pixel switching elements W connected to the gate wire Y1 for only one horizontal scan period, the gate driver YD outputs an off voltage for not electrically conducting the pixel switching elements W to the gate wire Y1. When the pixel switching elements W have become not electrically conducted, the compensation voltage Ve reduces the charge extracted from the pixel electrodes PE by the parasitic capacitances and substantially cancels the fluctuation of the pixel voltages Vs, that is, field-through voltages ΔVp.

When, for example, the upper left light source UL and the lower left light source DL of the backlight BL are turned on and turned off at the same timing and the upper right light source UR and the lower right light source DR thereof are turned on and turned off at the same timing, since the backlight BL can be turned on only during a period until next writing of a black signal begins after a picture signal has been written when an in-plane luminance inclination is taken into consideration, it is difficult to secure a sufficient turn-on period and display quality may be lowered.

To cope with the problem, in the embodiment, the light sources of the backlight BL disposed along the scan direction are permitted to be turned on and turned off at different timing.

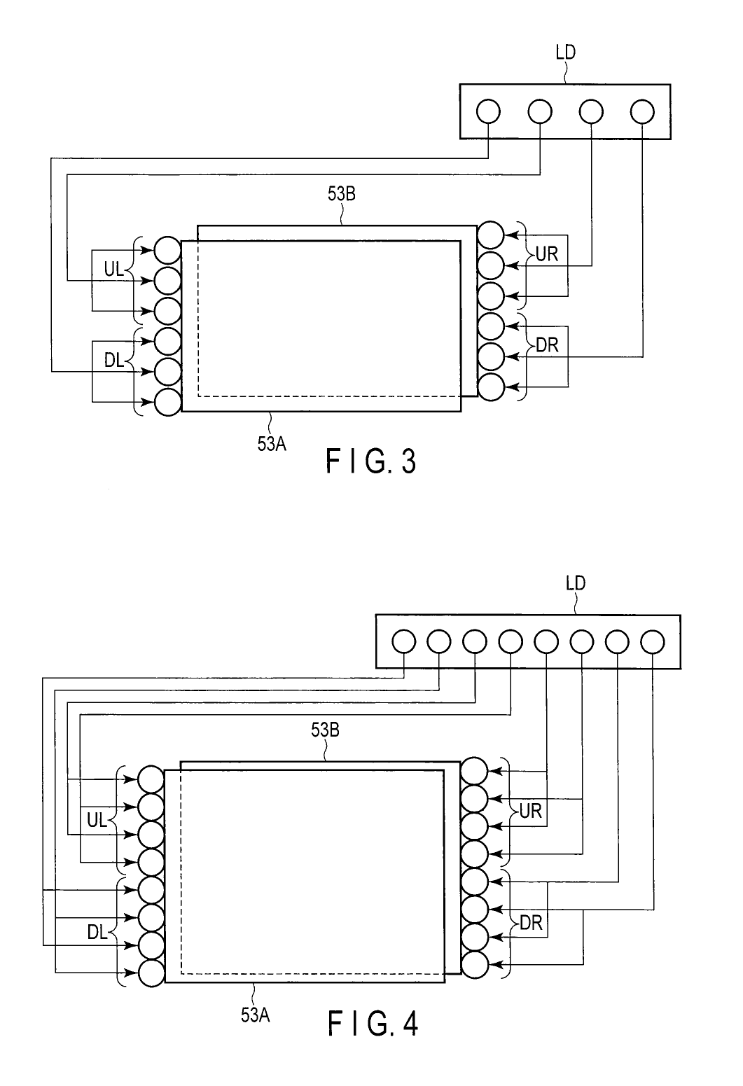

FIG. 3 is a view illustrating an example of the connection relation between output terminals of the backlight drive unit LD and the light sources. Illustrated here is a case that the number of the output terminals of the backlight drive unit LD is the same as the number of the portions of the backlight BL that are independently driven. Note that, in the embodiment, since the four portions (upper right, lower right, upper left, and lower left portions) of the light sources of the backlight BL are independently driven, this is a case that the backlight drive unit LD have four output terminals.

Each of the upper left light source UL, the lower left light source DL, the upper right light source UR, and the lower right light source DR has a plurality of light sources such as LEDs and the like. The respective light sources of each of the upper left light source UL, the lower left light source DL, the upper right light source UR, and the lower right light source DR are driven by a common drive signal (drive current) output from an output terminal of the backlight drive unit LD. The upper left light source UL, the lower left light source DL, the upper right light source UR, and the lower right light source DR are driven each other by a drive signal output from a different output terminal.

In other words, the backlight drive unit LD drives the plurality of light sources (first light sources) that emit light to the right side and the plurality of light sources (second light sources) that emit light to the left side in a plurality of units disposed in the scan direction. Accordingly, in each of the upper left light source UL, the lower left light source DL, the upper right light source UR, and the lower right light source DR, the plurality of light sources are driven so as to be able to be turned on and turned off at the same timing, and the upper left light source UL, the lower left light source DL, the upper right light source UR, and the lower right light source DR can be turned on and turned off independently from each other and can also independently adjust brightness by adjusting the drive signal.

FIG. 4 is a view illustrating other example of the connection relation between the output terminals of the backlight drive unit LD and the light sources. Here, a case that the number of the output terminals of the backlight drive unit LD is larger than the number of the portions of the backlight BL driven independently. Note that, described in the embodiment is a case that since the four portions (upper right, lower right, upper left, and lower left portions) of the light sources of the backlight BL are independently driven, the number of the output terminals of the backlight drive unit LD is more than four.

Each of the upper left light source UL, the lower left light source DL, the upper right light source UR, and the lower right light source DR has a plurality of light sources such as LEDs and the like. In the upper left light source UL, the lower left light source DL, the upper right light source UR, and the lower right light source DR, the light sources driven by a drive signal output from a different output terminal are disposed adjacent to each other in the scan direction. In other words, the backlight drive unit LD drives the light sources adjacent to each other in the scan direction, that is, the plurality of light sources (the plurality of first light sources) for emitting light to the right side and the plurality of light sources (the plurality of second light sources) for emitting light to the left side by a drive signal output from a different output terminal.

When the adjacent light sources are driven by the drive signal output from the different output terminal as described above, occurrence of uneven luminance in respective illumination regions that is caused by the dispersion of the drive signals depending on the output terminals can be suppressed. That is, when the drive signals output from the respective output terminals are dispersed, although illumination partly becomes dark (or bright), the deviation a dark portion (or bright portion) can be prevented by driving the adjacent light sources by a different drive signal so that display quality can be prevented from being lowered.

Further, the upper left light source UL, the lower left light source DL, the upper right light source UR, and the lower right light source DR are driven by the drive signals output from the output terminals different from each other. That is, the upper left light source UL, the lower left light source DL, the upper right light source UR, and the lower right light source DR can be turned on and turned off independently from each other.

Next, an example of a drive method of the liquid crystal display will be explained. In the embodiment, conversion into alternating current is performed to prevent the storage of a DC electric field by switching a polarity to be displayed every time the polarity is written. In the embodiment, at the time of 2D display, the gate driver YD and the source driver XD are effectively driven at 90 Hz, and, at the time of 3D display, the gate driver YD and the source driver XD are effectively driven at 120 Hz.

Note that the case, in which a user executes a visual recognition so that the scan direction is directed upward and downward at both the times the 2D display is made and the 3D display is made, will be explained.

The gate driver YD sequentially drives the gate wires Y. The gate driver YD receives the control signal CTY including a start pulse ST, a clock signal, and the like from the vertical timing control circuit 11, shifts the start pulse ST in the shift register circuit, and sequentially outputs the control signal CTY to the gate wires Y1-Ym.

The source driver XD receives the control signal CTX including a start signal, a clock signal, a load signal, a polarity signal, and the like and applies the pixel voltages Vs or the reverse transition prevention voltage to the plurality of source wires X in parallel. The reverse transition prevention voltage must be a relatively high voltage to prevent the orientation of the liquid crystal molecule from transiting from bend orientation to splay orientation (reverse transition). In the embodiment, it is assumed to employ a voltage corresponding to a black display as the reverse transition prevention voltage.

Next, the operation of the backlight BL when the 2D display is made will be explained.

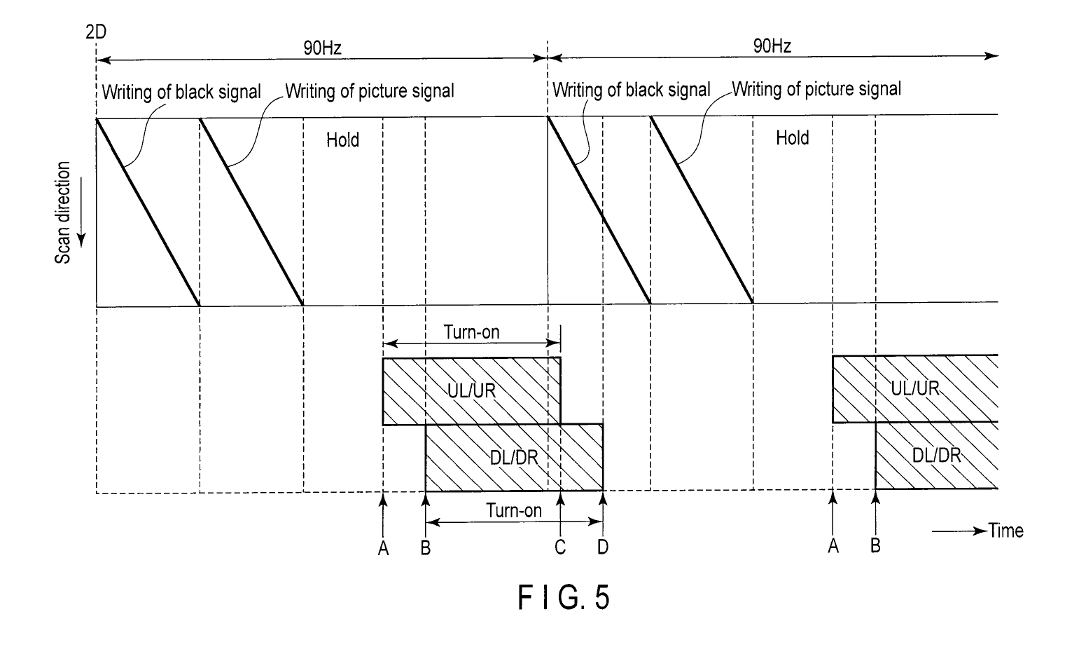

FIG. 5 is a view explaining an example of a drive method when the 2D display is made in the liquid crystal display.

In FIG. 5, a horizontal axis is a time axis, a vertical axis shows a scan direction, and FIG. 5 illustrates timing at which the reverse transition prevention voltage is written to the plurality of pixel electrodes PE (writing of the black signal), timing at which the pixel voltages Vs are written (writing of the picture signal), and timing at which the upper left light source UL, the lower left light source DL, the upper right light source UR, and the lower right light source DR are turned on.

In the embodiment, the black signal is written at the beginning of the one frame period.

The gate driver YD supplies a drive signal, which electrically conducts the pixel switching elements W of the respective rows for only one horizontal period H at the beginning of the one frame period by controlling the control signal CTY, to the selection gate wires Y and sequentially selects the gate wires Y1-Ym.

The source driver XD outputs a voltage corresponding to the black display to the plurality of source wires X1-Xn in parallel. The voltage applied to the source wires X1-Xn is written to the pixel electrodes PE via the conducted pixel switching elements W and is kept until the picture signal is written. The source driver XD sequentially writes the voltage corresponding to the black display to the pixel electrodes PE of one row every one horizontal period and writes the voltage corresponding to the black display to all the pixel electrodes PE in one vertical period.

On the completion of writing of the black signal, the gate driver YD supplies a drive signal for electrically conducting the pixel switching elements W of the respective rows only for the one horizontal period to the selection gate wires Y by controlling the control signal CTY and sequentially selects the gate wires Y1-Ym again.

The source driver XD receives picture signal data of one row from the image data conversion circuit 17, converts the picture signal data to the pixel voltages Vs referring to the predetermined number of the gradation reference voltages VREF supplied from the gradation reference voltage generation circuit 7, and outputs the pixel voltages Vs to the plurality of source wires X1-Xn in parallel. The pixel voltages Vs applied to the source wires X1-Xn are written to the pixel electrodes PE via the conducted pixel switching elements W and kept until the black signal is written next. The source driver XD sequentially writes the pixel voltages Vs to the pixel electrodes PE of the one row every one horizontal period and writes corresponding pixel voltages Vs to all the pixel electrodes PE within the one vertical period.

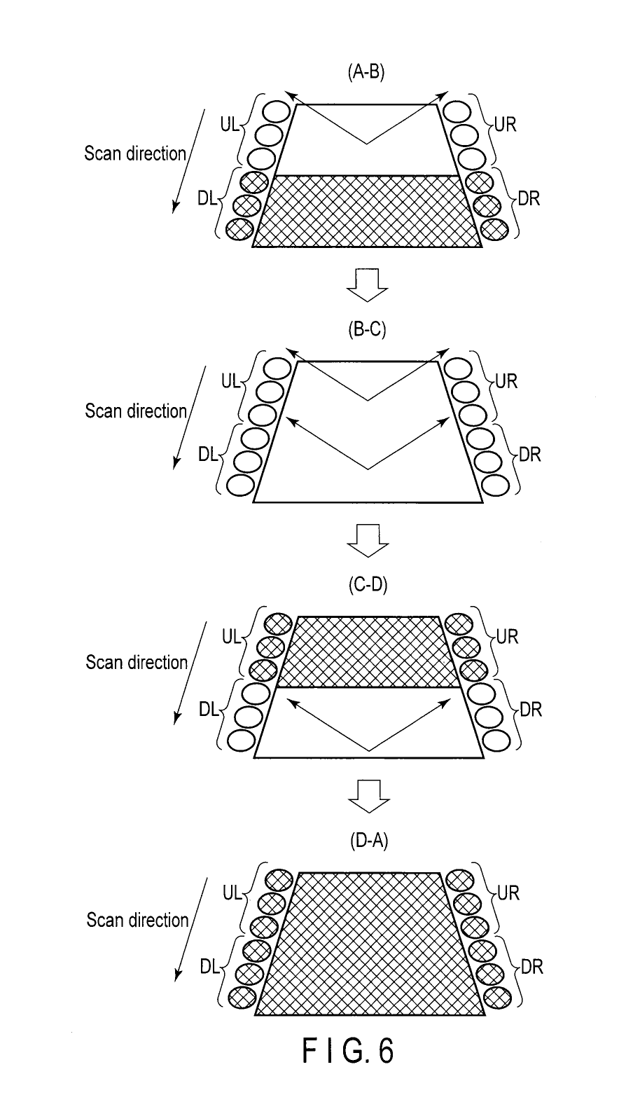

FIG. 6 is a view explaining an example of the turning-on and turning-off operations of the upper left light source UL, the lower left light source DL, the upper right light source UR, and the lower right light source DR of the backlight. After the picture signal has been written, the backlight BL is turned on in a period until the picture signal begins to be written next. That is, in respective frame periods, the backlight drive unit LD sequentially turns on and turns off the plurality of first light sources (the upper left light source UL and the lower left light source DL) and the plurality of second light sources (the upper right light source UR and the lower right light source DR) along the scan direction.

First, after the picture signal has been written and a predetermined period has passed, the upper left light source UL and the upper right light source UR are turned on at the same time (timing A). Here, as described in uppermost of FIG. 6, the backlight BL illuminates the upper portion of the display area of the liquid crystal panel DP (the start end side in the scan direction) toward the right side and the left side and the lower portion (the terminal end side in the scan direction) thereof remains dark.

After a predetermined period from the time at which the upper left light source UL and the upper right light source UR were turned on, the lower left light source DL and the lower right light source DR are turned on at the same time (timing B). Accordingly, the light sources UL, DL, UR, DR are turned on between the timing A and timing B, and, as described in a second portion from upper of FIG. 6, the backlight BL illuminates the upper portion and the lower portion of the display area of the liquid crystal panel DP toward the right side and the left side.

After a predetermined period from the time at which all the light sources UL, DL, UR, DR were turned on, the upper left light source UL and the upper right light source UR are turned off at the same time (timing C). Here, as described in a third portion from upper of FIG. 6, the backlight BL illuminates the lower portion of the display area of the liquid crystal panel DP toward the right side and the left side.

After predetermined period from the time at which the upper left light source UL and the upper right light source UR were turned off at the same time, the lower left light source DL and the lower right light source DR are turned off at the same time (timing D). Accordingly, all the light sources UL, DL, UR, DR are turned off from the timing D to next timing A, and, as described in lowermost of FIG. 6, the backlight BL does not illuminate the display area of the liquid crystal panel DP.

That is, in the embodiment, the light sources UL, DL, UR, DR of the backlight BL are sequentially turned on along the scan direction and sequentially turn off along the scan direction.

When, for example, the light sources UL, DL, UR, DR of the backlight BL are turned on and turned off at the same timing, since the backlight BL can be turned on only the period from the time at which the picture signal was written to the time at which the black signal begins to be written next when the in-plane luminance inclination is taken into consideration, it is difficult to secure a sufficient turn-on period and display quality may be lowered.

However, as described above, when the upper left light source UL, the lower left light source DL, the upper right light source UR, and the lower right light source DR of the backlight BL that are disposed side by side in the scan direction are turned on and turned off along the scan direction, since the backlight BL can be controlled in agreement with the timing at which the picture signal is written to the pixel electrodes PE, the in-plane luminance inclination can be reduced. Further, since a sufficient turn on period of the backlight BL can be secured, display quality can be prevented from being lowered. Note that the timing D is set before the picture signal begins to be written next.

Next, the operation when the 3D-display is made will be explained.

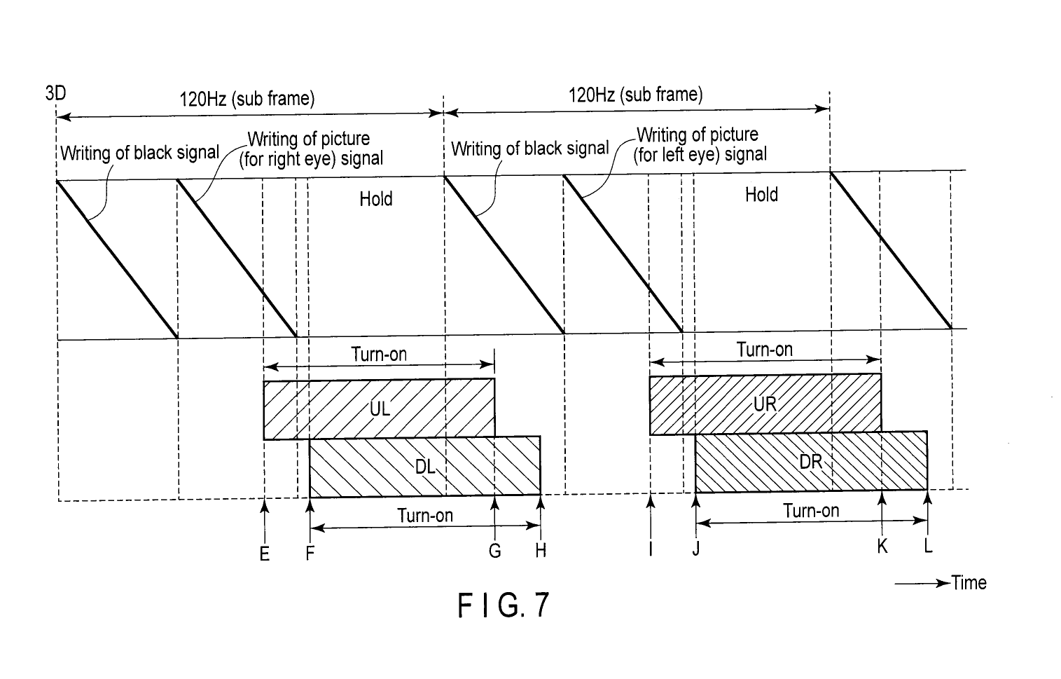

FIG. 7 is a view explaining an example of a drive method when the 3D-display is made in the liquid crystal display.

In FIG. 7, a horizontal axis is a time axis, a vertical axis shows a scan direction, and FIG. 7 illustrates timing at which the reverse transition prevention voltage is written to the plurality of pixel electrodes PE (writing of the black signal), timing at which the pixel voltages Vs are written (writing of the picture signal), and timing at which the upper left light source UL, the lower left light source DL, the upper right light source UR, and the lower right light source DR are turned on.

In the embodiment, the black signal is written at the beginning of respective subframe periods.

The gate driver YD supplies a drive signal, which electrically conducts the pixel switching elements W of the respective rows, to the selection gate lines Y for only the one horizontal period at the beginning of a subframe period by controlling the control signal CTY and sequentially selects the gate wires Y1-Ym.

The source driver XD outputs the voltage corresponding to the black display to the source wires X1-Xn in parallel. The voltage applied to the source wires X1-Xn is written to the pixel electrodes PE via the conducted pixel switching elements W and kept until the picture signal is written. The source driver XD sequentially writes the voltage corresponding to the black display to the pixel electrodes PE of the one row every one horizontal period and writes the voltage corresponding to the black display to all the pixel electrodes PE within the one vertical period.

On the completion of writing of the black signal, a right eye picture signal is written. The gate driver YD supplies the drive signal for electricity conducting the pixel switching elements W of the respective rows for only the one horizontal period to the selection gate wires Y by controlling the control signal CTY and sequentially selects the gate wires Y1-Ym again.

The source driver XD receives right eye picture signal data of one row from the image data conversion circuit 17, converts the right eye picture signal data to the pixel voltages Vs referring to the predetermined number of the gradation reference voltages VREF supplied from the gradation reference voltage generation circuit 7, and outputs the pixel voltages Vs to the plurality of source wires X1-Xn in parallel. The pixel voltages Vs applied to the source wires X1-Xn are written to the pixel electrodes PE via the conducted pixel switching elements W and kept until the black signal is written next. The source driver XD sequentially writes the pixel voltages Vs corresponding to the right eye picture signal data to the pixel electrodes PE of the one row every one horizontal period and writes the pixel voltages Vs corresponding to the right eye picture signal data to all the pixel electrodes PE within the one vertical period.

In a next subframe period, likewise the previous subframe period, after the black signal is written first, a left eye picture signal is written.

That is, after the gate driver YD and the source driver XD have written the black signal, the gate driver YD supplies the drive signal for electrically conducting the pixel switching elements W of the respective rows for only the one horizontal period to the selection gate wires Y by controlling the control signal CTY and sequentially selects the gate wires Y1-Ym again.

The source driver XD receives left eye picture signal data of one row from the image data conversion circuit 17, converts the left eye picture signal data to the pixel voltages Vs referring to the predetermined number of the gradation reference voltages VREF supplied from the gradation reference voltage generation circuit 7, and outputs the pixel voltages Vs to the plurality of source wires X1-Xn in parallel. The pixel voltages Vs applied to the source wires X1-Xn are written to the pixel electrodes PE via the conducted pixel switching elements W and kept until the black signal is written next. The source driver XD sequentially writes the pixel voltages Vs corresponding to the left eye picture signal data to the pixel electrodes PE of the one row every one horizontal period and writes the pixel voltages Vs corresponding to the left eye picture signal data to all the pixel electrodes PE within the one vertical period.

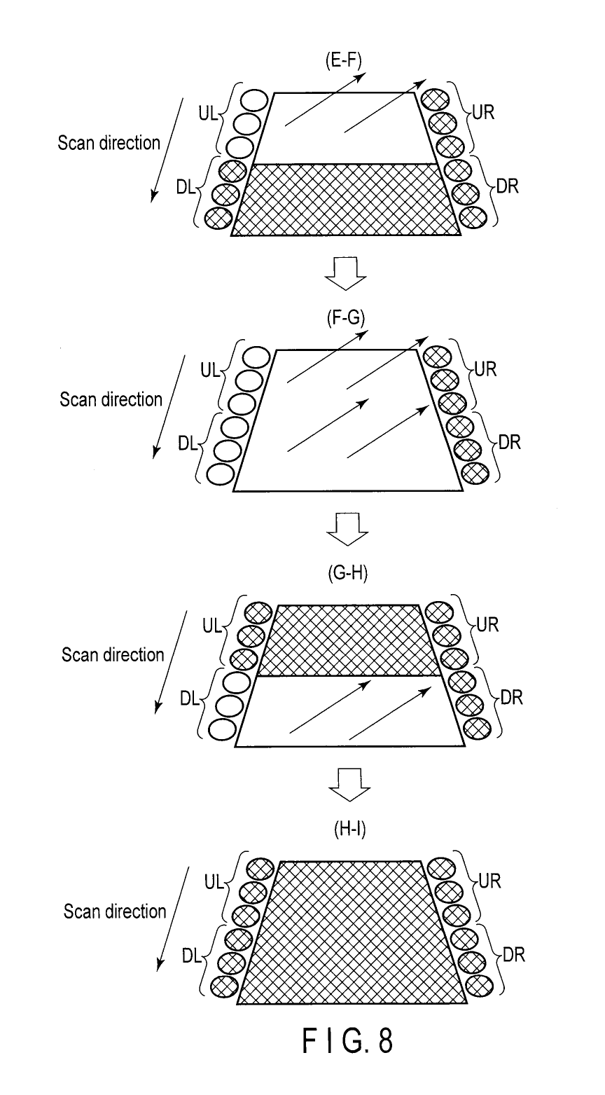

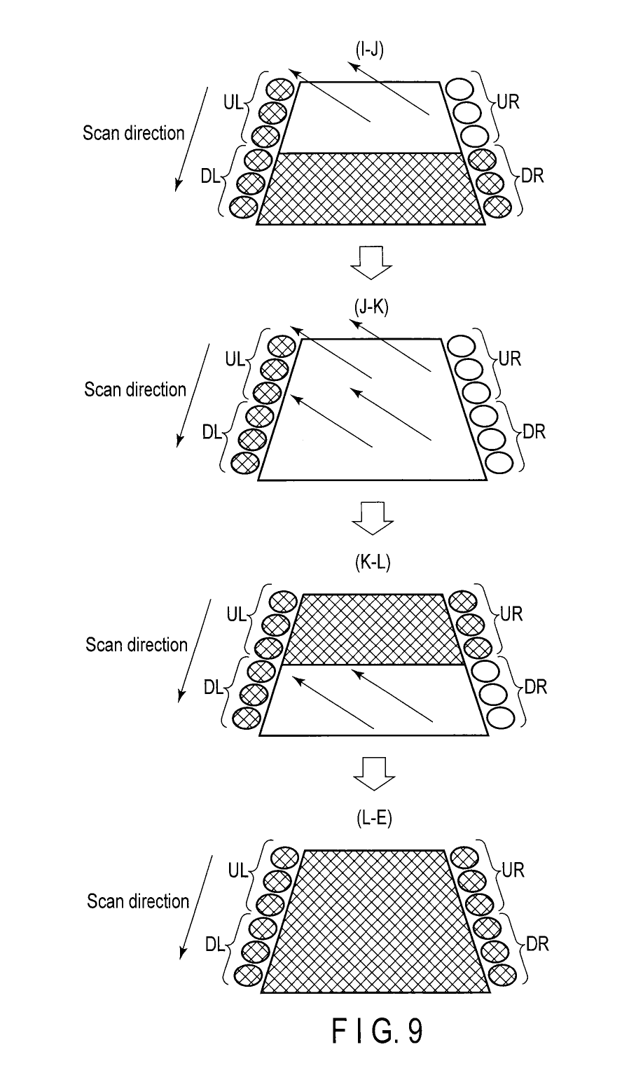

FIG. 8 and FIG. 9 are views explaining an example of a turning on/off operation of the light sources UL, DL, UR, DR of the backlight at the time of 3D display. The backlight BL is turned on during the period from the time at which the picture signal began to be written to the time at which the picture signal begins to be written next.

First, after a predetermined period has passed from the beginning of writing of the right eye picture signal, the upper left light source UL is turned on (timing E). Here, as described in uppermost of FIG. 8, the backlight BL illuminates the upper portion of the display area of the liquid crystal panel DP toward the right side.

After a predetermined period has passed from the turn-on of the upper left light source UL, the lower left light source DL is turned on (timing F). Accordingly, between timing F and timing G, the light sources UL, DL are turned on, and, as described in a second portion from upper of FIG. 8, the backlight BL illuminates the upper portion and the lower portion of the display area of the liquid crystal panel DP toward the right side.

After a predetermined period has passed from the turn-on of both the upper left light source UL and the lower left light source DL, the upper left light source UL is turned off (timing G). Only the lower left light source DL is turned on between the timing G and timing H, and, as described in a third portion from upper of FIG. 8, the backlight BL illuminates the lower portion of the display area of the liquid crystal panel DP toward the right side.

After a predetermined period has passed from the turn-off of the upper left light source UL, the lower left light source DL is also turn off (timing H). All the light sources UL, DL, UR, DR are turn off between the timing H and timing I of a next subframe period.

In a next subframe period, after a predetermined period has passed from the beginning of writing of the left eye picture signal, the upper right light source UR is turn on (timing I). Here, as described in uppermost of FIG. 9, the backlight BL illuminates the upper portion of the display area of the liquid crystal panel DP toward the left side.

After a predetermined period has passed from the turn-on of the upper right light source UR, the lower right light source DR is turned on (timing J). Accordingly, the light sources UR, DR are turned on between the timing J and timing K, and, as described in a second portion from upper of FIG. 9, the backlight BL illuminates the upper portion and the lower portion of the display area of the liquid crystal panel DP toward the left side.

After a predetermined period has passed from the turn-on of both the upper right light source UR and the lower right light source DR, the upper right light source UR is turned off (timing K). Only the lower right light source DR is turned on between the timing K and timing L, and, as described in a third portion from upper of FIG. 9, the backlight BL illuminates the lower portion of the display area of the liquid crystal panel DP toward the left side.

After a predetermined period has passed from the turn-off of the upper right light source UR, the lower right light source DR is also turn off (timing L). All the light sources UL, DL, UR, DR are turned off between the timing L and timing E of a next subframe period.

As described above, since the plurality of light sources that can be independently driven along the scan direction are disposed and the light sources are sequentially turned on and turned off along the scan direction, the in-plane luminance inclination can be taken into consideration and the sufficient turn-on period can be secured. Accordingly, display quality can be prevented from being lowered by suppressing the in-plane luminance inclination and suppressing luminance from being lowered.

Note that, at the time of the 3D display, timing at which the backlight BL is turned off in the respective subframe periods is set before the picture signal begins to be written and a scan is begun in a next subframe period. Occurrence of crosstalk can be prevented and display quality can be prevented from being lowered by setting the turn-off timing of the backlight BL in the respective subframe periods at the time of the 3D display as described above.

That is, according to the liquid crystal display of the embodiment, there can be provided a liquid crystal display that prevents display quality from being lowed.

Note that, in the embodiment, although the region illuminated by the backlight BL is divided to the upper portion and the lower portion on each of the right and the left side, it is sufficient that the region is divided to two or more regions on each of the right and left sides, respectively. Even the case in which the two or more regions, to which illumination is executed, are set to each of the right and left sides can also obtain the same effect as that of the embodiment described above by sequentially illuminating the two or more regions on the right and left sides along the scan direction.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display, comprising:
a pair of substrates;
a liquid crystal layer sandwiched between the pair of substrates;
a plurality of liquid crystal pixels disposed in a matrix state;
a drive circuit configured to drive the liquid crystal pixels;
a plurality of first light sources disposed side by side in a scan direction along which the liquid crystal pixels are scanned by the drive circuit;
a first light guide configured to guide the light emitted from the first light sources in a first direction;
a plurality of second light sources disposed side by side in the scan direction;
a second light guide configured to guide the light emitted from the second light sources in a second direction different from the first direction; and
a light source drive unit configured to be able to independently turn on and turn off the first light sources and the second light sources,
wherein the light source drive unit sequentially turns on and turns off the first light sources along the scan direction in a first subframe period, the light source drive unit sequentially turns on and turns off the second light sources along the scan direction in a second subframe period succeeding to the first subframe period, and the light source drive unit turns off all the first light sources and the second light sources before a picture signal begins to be written in a next subframe period.

2. The liquid crystal display according to claim 1, wherein the light source drive unit sequentially turns on and turns off the first light sources and the second light sources along the scan direction in respective frame periods.

3. The liquid crystal display according to claim 1, wherein each of the first light sources and the second light sources comprises a plurality of light sources disposed in the scan direction.

4. The liquid crystal display according to claim 2, wherein each of the first light sources and the second light sources comprises a plurality of light sources disposed in the scan direction.

5. The liquid crystal display according to claim 1, wherein the light source drive unit drives the light sources, which are adjacent in the scan direction, of the first light sources and the second light sources by a different drive signal.

6. The liquid crystal display according to claim 2, wherein the light source drive unit drives the light sources, which are adjacent in the scan direction, of the first light sources and the second light sources by a different drive signal.

7. The liquid crystal display according to claim 1, wherein:
the liquid crystal layer comprises an OCB mode liquid crystal; and
the drive unit writes a reverse transition prevention voltage to the liquid crystal pixels in respective frame periods or in respective subframe periods.

8. The liquid crystal display according to claim 2, wherein:
the liquid crystal layer comprises an OCB mode liquid crystal; and
the drive unit writes a reverse transition prevention voltage to the liquid crystal pixels in respective frame periods or in respective subframe periods.
